(19) United States
(12) Patent Application Publication
(10) Pub. No.: US 2011/0278408 A1
(43) Pub. Date: Nov. 17, 2011

(54) LOCKING DEVICE

(75) Inventor: Jeffrey C. BISHOP, Derby (GB)

(73) Assignee: ROLLS-ROYCE PLC, London (GB)

(21) Appl. No.: 13/099,612

(22) Filed: May 3, 2011

(30) Foreign Application Priority Data
May 17, 2010 (GB) 1008162.8

(51) Int. Cl. F16B 2/10; F16B 2/06

(52) U.S. Cl. 248/231.51; 248/226.11

(57) ABSTRACT

A locking device adapted to lock a component to a locking surface, the locking device comprising a body and a lever, the lever being movable with respect to the body from an open position, in which the locking device is open to receive the component, to a closed position, in which the component is locked against the locking surface, wherein the lever comprises: a first abutment surface arranged to abut the component and lock the component against the locking surface when in the closed position; and a second abutment surface arranged such that upon insertion of the component into the locking device, the component abuts the second abutment surface to urge the lever from the open position to the closed position. The locking device may further comprise one or more knife edge pivot points arranged between the body and the lever such that the lever may be rotatable from the open position to the closed position.

The present disclosure relates to a locking device and method for locking a component to a locking surface and particularly but not exclusively relates to a locking device and method with a low wearing and/or automatic locking lever.

### BACKGROUND

In many manufacturing applications, there is a common tendency to use manually operated ‘toggle’ type clamps for clamping a component or workpiece to a work surface. See for example U.S. Pat. No. 4,407,493, U.S. Pat. No. 2,456,100, U.S. Pat. No. 2,436,941 and U.S. Pat. No. 2,835,291. Typically, these clamps operate in a binary fashion between open and closed positions and are extremely popular because of their propensity for adaptation. However, it is their ease of adaptation and rapid wear-rate that renders them unsatisfactory for positional clamping. For example, previously-proposed toggle clamps may be adjustable to compensate for wear. As a result, operators often readjust the clamp to give what they feel is the correct clamping condition. However, different operators have a different feel for what is an acceptable clamping force and this may result in a different component response under the action of a disturbing force. This is clearly not a practice commensurate with the installation of process-control for which accurately repeatable clamping is desirable. Furthermore, the previously-proposed toggle clamps are slow to use as they require activation of the clamp once the component to be clamped is in place.

The present invention seeks to address these issues.

### STATEMENTS OF INVENTION

According to a first aspect of the present disclosure there is provided a locking device adapted to lock a component to a locking surface, the locking device comprising a body and a lever, the lever being movable with respect to the body from an open position, in which the locking device is open to receive the component, to a closed position, in which the component is locked against the locking surface, wherein the lever comprises: a first abutment surface arranged to abut the component and lock the component against the locking surface when in the closed position; and a second abutment surface arranged such that upon insertion of the component into the locking device, the component abuts the second abutment surface to urge the lever from the open position to the closed position.

The locking device may further comprise one or more knife edge pivot points. The knife edge pivot points may be arranged between the body and the lever such that the lever may be rotatable with respect to the body from the open position to the closed position.

According to a second aspect of the present disclosure there is provided a locking device adapted to lock a component to a locking surface, the locking device comprising a body and a lever, the lever being movable with respect to the body from an open position, in which the locking device is open to receive the component, to a closed position, in which the component is locked against the locking surface, wherein the lever comprises a first abutment surface arranged to abut the component and lock the component against the locking surface when in the closed position; and wherein the locking device further comprises one or more knife edge pivot points arranged between the body and the lever such that the lever is rotatable from the open position to the closed position.

The lever may further comprise a second abutment surface arranged such that upon insertion of the component into the locking device, the component may abut the second abutment surface to urge the lever from the open position to the closed position.

The lever may be configured such that when the lever is in the open position, the component may freely contact the second abutment surface. The first abutment surface may be configured such that the component may abut the second abutment surface to urge the lever from the closed position to the open position upon removal of the component.

An equilibrium position may exist between the open and closed positions. The locking device may further comprise a biasing means. The biasing means may be arranged such that the lever may be biased, eg resiliently, into the open position and/or the closed position. The biasing means may bias the lever away from the equilibrium position. The locking device may be arranged to provide a repeatable clamping force.

The locking device may comprise a clamp. The locking device may be bistable. The open and closed positions may be stable positions. When the lever is perturbed from the equilibrium position it may tend to move to either of the open or closed positions. Furthermore, the lever may toggle from the open position to the closed position and vice versa. In other words, the locking device may comprise an over-centre mechanism. The locking device may comprise a mechanical stop limiting further movement of the lever in the open position.

The lever may comprise first and second jaws. The first and second jaws may be arranged to receive the component. The first jaw may comprise the first abutment surface. The second jaw may comprise the second abutment surface. The first and second jaws may be disposed opposite one another.

The locking device may further comprise adjusting means. The adjusting means may be arranged to adjust the biasing force applied by the biasing means. The biasing means may comprise a leaf spring, for example with a single leaf. The leaf spring may be coupled to the body at first and/or second ends of the leaf spring. The leaf spring may be coupled to the lever at a point between the first and second ends of the leaf spring. The leaf spring may be coupled to the adjusting means at the first or second end of the leaf spring. The leaf spring may be coupled to the body and/or lever by one or more pivot points between the leaf spring and the body and/or lever. One or more of the leaf spring pivot points may comprise a knife edge pivot. The leaf spring may comprise a knife portion of the knife edge pivot. Alternatively, the body and/or lever may comprise the knife edge portion of the knife edge pivot.

The locking device may further comprise a pivot member, which may for example be an elongate member, eg in the form of a strut or bar. The pivot member may comprise first and second pivot points. The first pivot point may be arranged to pivot with respect to the lever. The second pivot point may be arranged to pivot with respect to the body. The first and second pivot points may be arranged at first and second ends of the pivot member respectively. One or more of the pivot member pivot points may comprise a knife edge pivot. The pivot member may comprise a knife portion of the knife edge pivot. Alternatively, the lever and/or body may comprise the knife edge portion of the knife edge pivot.

According to a third aspect of the present disclosure there is provided a method of locking a component to a locking surface, the method comprising: providing a locking device with a body and a lever, the lever being movable with respect to the body from an open position, in which the locking device is open to receive the component, to a closed position, in which the component is locked against the locking surface; inserting the component into the locking device; urging the lever into the closed position with a second abutment surface provided on the lever by abutting the component against the second abutment surface; and locking the component against the locking surface with a first abutment surface provided on the lever by abutting the first abutment surface against the component.

According to a fourth aspect of the present disclosure there is provided a method of locking a component to a locking surface, the method comprising: providing a locking device with a body and a lever, the lever being movable with respect to the body from an open position, in which the locking device is open to receive the component, to a closed position, in which the component is locked against the locking surface; inserting the component into the locking device; rotating the lever from the open position to the closed position about one or more knife edge pivot points arranged between the body and the lever; and locking the component against the locking surface with a first abutment surface provided on the lever by abutting the first abutment surface against the component.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 shows an example of a locking device in open (FIG. 1a), equilibrium (FIG. 1b) and closed (FIG. 1c) positions; and

FIG. 2 shows a further example of the locking device during various stages of the locking and unlocking process.

### DETAILED DESCRIPTION

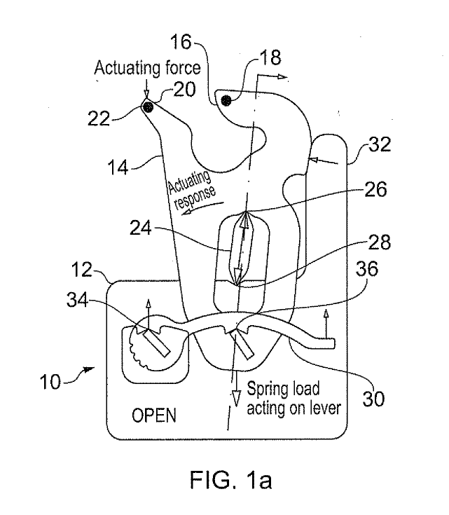

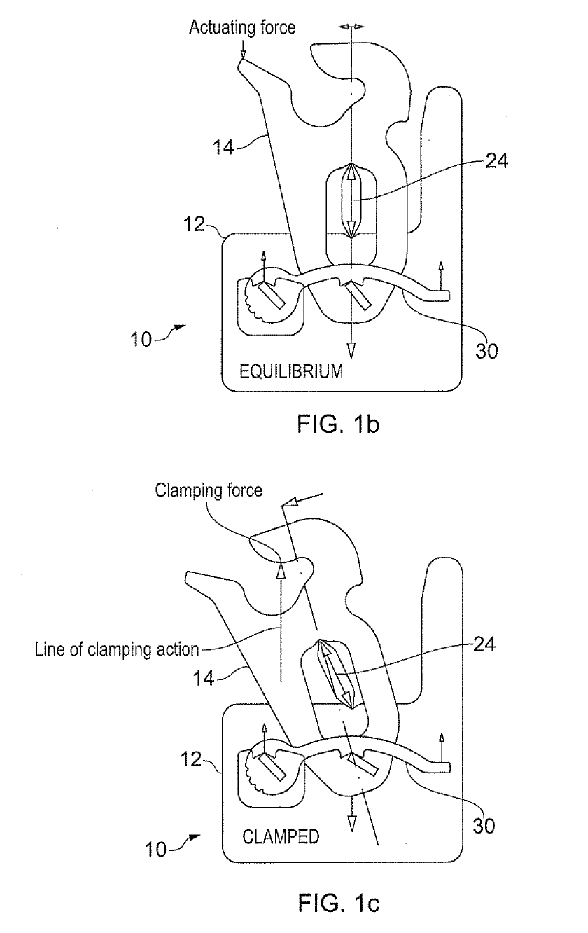

With reference to FIG. 1, a locking device 10, according to an example of the present invention, may be adapted to lock a component (not shown) to a locking surface (not shown). The locking device 10 may comprise a body 12 and a lever 14. The lever 14 may be rotated about one or more axes with respect to the body 12. The lever 14 may move from an open position (as shown in FIG. 1a), in which the locking device is open to receive the component, to a closed position (as shown in FIG. 1c), in which the component is locked against the locking surface. The lever 14 may comprise a first abutment surface 16 provided on a first arm or jaw 18. The first abutment surface 16 may be arranged to abut the component and lock the component against the locking surface when the locking device 10 is in the closed position. The lever 14 may further comprise a second abutment surface 20 provided on a second arm or jaw 22. The second abutment surface 20 may be arranged such that upon insertion of the component into the locking device 10, the component abuts the second abutment surface 20 to urge the lever 14 from the open position to the closed position. The first abutment surface 18 may be arranged such that upon removal of the component from the locking device 10, the component abuts the first abutment surface 18 to urge the lever 14 from the closed position to the open position.

The first and second jaws 18, 22 may be arranged to receive the component. For example, the first and second jaws may be disposed opposite one another at one end of the lever 14. The first and second jaws 18, 22 may define an opening for receiving the component. The first and second jaws 18, 22 may be arranged such that the component contacts the second jaw 22 to move the lever 14 into the closed position in which the first jaw 18 clamps the component to the locking surface. The shape of the clamping first jaw 18 and activating second jaw 22 of the lever 14 may be determined by the shape of the component to be clamped and the desired withdrawal direction.

The first jaw 18 may be configured such that when the lever 14 is in the open position, the component may freely contact the second jaw 22 without contacting the first jaw upon insertion of the component. The first jaw 18 may be configured such that when the lever is in the closed position, the component may urge the lever into the open position upon removal of the component. For example, the first abutment surface 16 provided on the first jaw 18 may comprise a curved portion, which the component may contact during removal. The curved portion may roll with respect to the component as the lever 14 rotates from the open closed position to the open position. The curved portion may be shaped such that a tangent of the curved portion at the point of contact corresponds to the shape of the component during unidirectional removal. Furthermore, the second jaw 22 may be configured such that unidirectional removal of the component is permitted. The second jaw 22 may be shaped such that once the component is clear of the first jaw 18, the second jaw urges the component away from the locking device 10.

The locking device 10 may further comprise a pivot member 24, which may for example be an elongate member, eg in the form of a strut or bar. The pivot member 24 may comprise first and second pivot points 26, 28. The pivot member 24 may pivot with respect to the lever 14 about the first pivot point 26. The pivot member 24 may pivot with respect to the body 12 about the second pivot point 28. The first and second pivot points 26, 28 may be arranged at first and second ends of the pivot member 24 respectively. One or more of the pivot member 24 pivot points 26, 28 may comprise a knife edge pivot or fulcrum. The pivot member 24 may comprise a knife portion of the knife edge pivot. Alternatively, the lever 14 and/or body 12 may comprise the knife edge portion of the knife edge pivot.

The locking device 10 may further comprise a biasing means 30. The biasing means 30 may be arranged to bias the lever 14 in a direction so that the lever 14 urges the pivot member 24 towards the body 12. The biasing means may thus be arranged to hold the lever 14 and body 12 together. The biasing means 30 may be further arranged such that the lever 14 may be resiliently biased into the open position and/or the closed position. The biasing means 30 may bias the lever 14 away from an equilibrium position (as shown in FIG. 1b), which may exist between the open and closed positions. The locking device 10 may comprise a mechanical stop 32 arranged to limit movement of the lever 14 beyond the open position. The mechanical stop 32 may be provided on a portion of the body 12.

The biasing means 30 may comprise a beam spring or a leaf spring, for example with a single leaf. The biasing means 30 may be elongate and may be coupled to the body 12 at first and second ends. The biasing means 30 may be coupled to the lever 14 at a point between the first and second ends of the biasing means. Instead of a spring arrangement, the biasing means 30 may alternatively comprise hydraulic, pneumatic, electric, magnetic or any other means to provide the deflections and clamping loads required.

The biasing means 30 may be coupled to the body 12 at a first end of the biasing means by virtue of a third pivot point 34. The biasing means 30 may be coupled to the body 12 at a second end of the biasing means. The biasing means 30 may be coupled to the lever 14 at a point between the first end and second end of the biasing means by virtue of a fourth pivot point 36. One or more of the third and fourth pivot points 34, 36 may comprise a knife edge pivot. As shown, the body 12 and lever 14 may comprise the knife edge portion of the knife edge pivot. Alternatively, the biasing means 30 may comprise a knife portion of the knife edge pivot.

The open and closed positions of the locking device 10 may be stable positions such that the locking device may be bistable. In other words, when the lever 14 is perturbed from the equilibrium position it may tend to move to either of the open or closed positions. As a result, the lever 14 may toggle from the open position to the closed position and vice versa and the locking device 10 may comprise an over-centre mechanism. The locking device 10 may be arranged to provide a repeatable clamping force. The locking device 10 may be applied to any object that needs to be firmly held in a fixed position and subsequently released by applying withdrawal-forces to the clamped object, for example, clamps, latches, door-catches, locks.

The range of total movement of the lever 14 may be expressed as: {(clamped position to equilibrium position)+(equilibrium position to open position)}. Similarly, a ratio of the distances from the open and closed positions to the equilibrium position may be expressed as: (clamped position to equilibrium position)/(equilibrium position to open position). Such a ratio may be approximately 2:1. The actual ratio for a specific locking device may be dependent on the shape and position of the component being clamped and the shape of the first jaw 18 required to permit unidirectional withdrawal of the component. In other words, the profile of the lever jaws 18, 22 may not only be defined by the ability to freely insert the component to invoke the clamped position, but the profile of the lever jaws 18, 22 may also be defined to allow unidirectional removal of the component. In this last respect, and although the profile of the first jaw 18 must be such that it comprises a portion suitable for clamping, it may also be shaped so that it allows synchronous clearance during unidirectional component removal. Thus, although a ratio of 2:1 may be a reasonable starting point for the locking device design, the optimum ratio between movements may vary depending on the application.

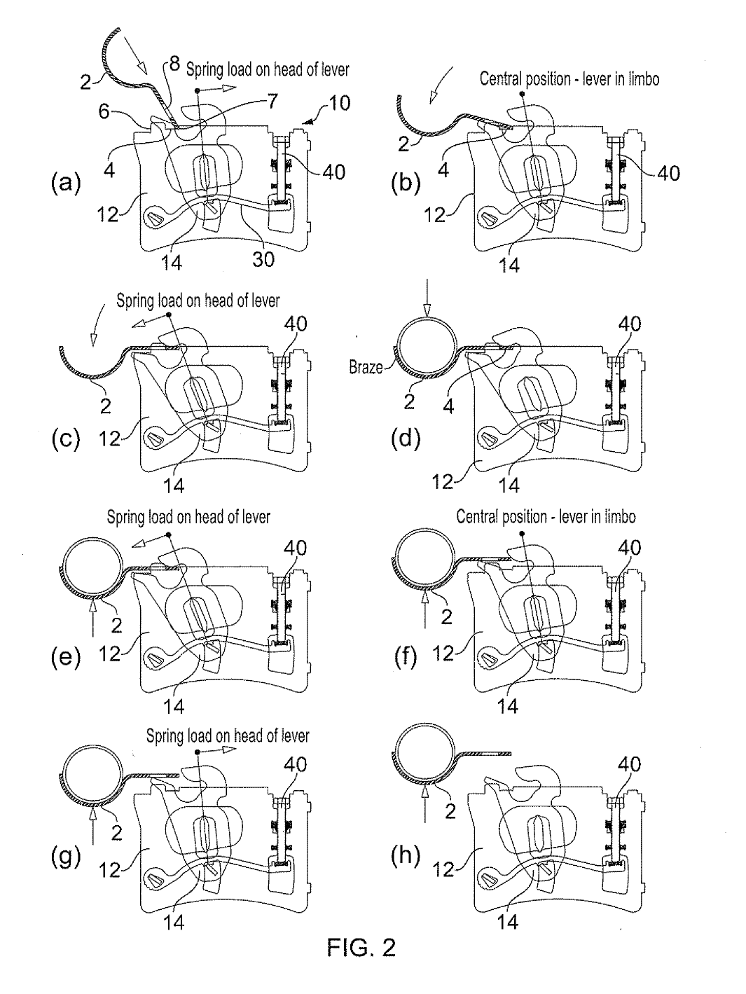

FIG. 2 shows an example of a complete operational sequence for locking a component 2 to a locking surface 4 with a further example of the locking device 10. In the particular example shown, the component 2 comprises a bracket onto which a pipe is to be secured. The locking device 10 holds the bracket in place whilst the bracket and pipe are joined, eg brazed together. The locking surface 4 may comprise a locating pin 6, which engages with a corresponding locating hole 8 provided in the component 2. The locking surface 4 may further comprise a locating ledge 7, which engages with an end of the component 2 to assist in the correct positioning of the component.

As shown in FIG. 2, the further example of the locking device 10 may comprise adjusting means 40. The adjusting means 40 may be arranged to adjust the biasing force applied by the biasing means 30. The biasing means 30 may be coupled to the body 12 at the first end of the biasing means and the biasing means may be coupled to the adjusting means 40 at the second end of the biasing means. The adjusting means 40 may comprise a screw threaded into the body 12. By turning the screw, the position of an end of the screw and hence the second end of the biasing means (i.e. fourth pivot point 36) may be adjusted. As the position of the first end of the biasing means may be fixed (eg relative to the body 12), the force applied by the biasing means 30 to the lever 14 may therefore also be adjusted.

With reference to FIG. 2, the method of locking and unlocking the component 2 to the locking surface 4 may be summarised as follows:
(a) With the lever 14 in the open position, the component may be loaded, for example against the locating edge 7.
(b) The component 2 may be rotated against the locating edge 7 so that the lever 14 may be forced to rotate over centre (ie from the open position (FIG. 1a) and through the equilibrium position (FIG. 1c)) by virtue of the component 2 contacting the second abutment surface 20.
(c) Lever 14 forced over centre and into the closed position (FIG. 1b) with the spring load of the biasing means 30 now clamping the component 2. The locating hole 8 engages the locating pin 6.
(d) A further component (eg pipe) may be placed on the component 2 and the two components may be joined (eg brazed) together.
(e) Removal of the components may be initiated.
(f) Lifting the components forces the lever 14 towards the equilibrium position by virtue of the component contacting the first abutment surface 16.
(g) Reversal of the biasing means 30 spring load once past the equilibrium position helps to eject the components.
(h) The components may be released from the locking device 10 and the lever 14 may be returned to the open position.

The locking device 10 of the present disclosure may be described as self-sensing in that it senses the insertion of the component 2 and operates the clamping action. Similarly, the locking device 10 may sense withdrawal of the component 2 and releases the clamping action. The locking device 10 may also be described as being quantized in that the clamping load and clamping position may be pre-set. The locking device may be referred to as a Self-Sensing Quantized Clamp (SQC).

In the majority of circumstances, the loading of components into clamps is a manual process. After placing the component the operator also has to operate the clamp-mechanism to achieve the clamped condition. Following the manufacturing process, and in order to retrieve the post-process component, the operator is further required to undo the clamp. By contrast, the locking device 10 of the present disclosure senses the placing of the component and automatically clamps it in position in a single action. Removal of the post-process component is achieved by simply lifting the component out of the locking device, again, in a single action.

An appropriate use of the locking device is within manufacturing processes that require the assembly of a variety of different components by means of mechanical or heat-related processes, where external loads on clamped components may be very low or near-zero. However, in some circumstances, for example where a number of locking devices are used collectively, it may be desirable that the available direction of withdrawal of an integrated assembly may be parallel to the line of clamping action of the locking device, or, conversely, the line of clamping action of all locking devices may be parallel to each other and to the intended direction of withdrawal of the integrated assembly.

The locking device 10 may be most relevant to the manufacture of pipes and ducts, for example in automotive or aeronautical industries, where the positioning of brackets and ‘j’ blades can be extremely problematical. Note also that the locking device may be ideal for use with robot-assembly, as its self-sensing and locating properties help minimise the total number of robot manipulations.

In order to reduce friction and the wear-rate of the locking device, knife-edge fulcrums may be used at one or more of the pivot points. Being unidirectionally loaded, knife-edges avoid the problems of bearing-slop and constant calibration typical of the prior art toggle clamps. Thus the locking device of the present disclosure is endowed with a precise and repeatable mechanism.

The locking device 10 disclosed herein is simple to use. The (one-handed) act of picking and placing a component (manually or robotically) is sufficient to properly clamp the component, for example as part of a manufacturing process. Following that manufacturing process, removal of the component (and any attachment) may be unidirectional and its release mechanism completely automatic. Further advantages may be summarised as follows:
Self-Sensing/Self-Operating
Clamping load is pre-set (quantised), independent of operator influence and therefore repeatable
Repeatable component response to clamping load
One-handed operation allows two components to be placed simultaneously
One-handed operation allows quicker process times
Automatic release upon component withdrawal allows quicker process times
Use of knife-edge bearings prolongs maintenance intervals and reduces friction
Simple
Low cost
Easily adaptable

1. A locking device adapted to lock a component to a locking surface, the locking device comprising a body and a single lever, the lever being movable with respect to the body from an open position, in which the locking device is open to receive the component, to a closed position, in which the component is locked against the locking surface, wherein the lever comprises:
a first abutment surface arranged to abut the component and lock the component against the locking surface when in the closed position; and
a second abutment surface arranged such that upon insertion of the component into the locking device, the component abuts the second abutment surface to urge the lever from the open position to the closed position.

2. The locking device as claimed in claim 1, wherein the locking device further comprises one or more knife edge pivot points arranged between the body and the lever such that the lever is rotatable from the open position to the closed position.

3. The locking device as claimed in claim 1, wherein the lever is configured such that when the lever is in the open position, the component may freely contact the second abutment surface.

4. The locking device as claimed in claim 1, wherein the first abutment surface is configured such that the component abuts the second abutment surface to urge the lever from the closed position to the open position upon removal of the component.

5. The locking device as claimed in claim 1, wherein an equilibrium position exists between the open and closed positions.

6. The locking device as claimed in claim 1, wherein the locking device further comprises a biasing means, the biasing means being arranged such that the lever is resiliently biased into the open position and/or the closed position.

7. The locking device as claimed in claim 6, wherein the locking device further comprises adjusting means, the adjusting means being arranged to adjust the biasing force applied by the biasing means.

8. The locking device as claimed in claim 6, wherein the biasing means comprises a leaf spring, the leaf spring being coupled to the body at first and/or second ends of the leaf spring and coupled to the lever at a point between the first and second ends of the leaf spring.

9. The locking device as claimed in claim 8, wherein the leaf spring is coupled to the adjusting means at the first or second end of the leaf spring.

10. The locking device as claimed in claim 8, wherein the leaf spring is coupled to the body and/or lever by one or more pivot points between the leaf spring and the body and/or lever.

11. The locking device as claimed in claim 1, wherein the locking device further comprises a pivot member, the pivot member comprising first and second pivot points, the first pivot point arranged to pivot with respect to the lever and the second pivot point arranged to pivot with respect to the body.

12. The locking device as claimed in claim 10, wherein one or more of the pivot points comprises a knife edge pivot.

13. A method of locking a component to a locking surface, the method comprising:
providing a locking device with a body and a single lever, the lever being movable with respect to the body from an open position, in which the locking device is open to receive the component, to a closed position, in which the component is locked against the locking surface;
inserting the component into the locking device;
urging the lever into the closed position with a second abutment surface provided on the lever by abutting the component against the second abutment surface; and
locking the component against the locking surface with a first abutment surface provided on the lever by abutting the first abutment surface against the component.

14. A method of locking a component to a locking surface as claimed in claim 13 further comprising the step of
rotating the lever from the open position to the closed position about one or more knife edge pivot points arranged between the body and the lever.
